(19) United States
(12) Patent Application Publication
(10) Pub. No.: US 2011/0083172 A1
(43) Pub. Date: Apr. 7, 2011

(54) INCREASE ENTROPY OF USER-CHOSEN PASSWORDS VIA DATA MANAGEMENT

(75) Inventors: Jason M. Heim, Poughkeepsie, NY (US); Thomas E. Murphy, Jr., Poughkeepsie, NY (US)

(73) Assignee: INTERNATIONAL BUSINESS MACHINES CORPORATION, Armonk, NY (US)

(21) Appl. No.: 12/574,999

(22) Filed: Oct. 7, 2009

(51) Int. Cl. H04L 29/06; G06F 7/04

(52) U.S. Cl. 726/6

(57) ABSTRACT

A method, computer readable medium and apparatus for providing data security for a computing environment having a plurality of nodes are provided. The apparatus comprises of a password mechanism residing in a storage location in the computing environment; and a user specific dictionary including entries generated by the password mechanism about each user by retrieving available data from one or more databases. The password mechanism rejects a proposed password for the user by comparing it with entries in the user specific dictionary when the proposed password matches at least part of any entry in the user specific dictionary.

### BACKGROUND OF THE INVENTION

1. Field of the Invention

This invention relates generally to password security systems, and more particularly to a method and apparatus for increasing entropy of user chosen data via data management.

2. Description of Background

Security of computer networks has become of utmost importance as individuals and businesses store and transmit information of both sensitive and confidential nature on and across these networks. Secure environments are created by employing mechanisms that offer protection to the information that is stored within them. Some of the most popular of these security mechanisms are password based. The conventional password based systems often involve the selection of a string of alpha numeric characters that are either user selected or administratively assigned to enable entry into the system. The effectiveness of these security mechanisms largely depends upon the ability to protect the password entry point throughout the duration of network access and over time. Unfortunately, in recent years there has been a continuous increase in the number of attempts made in order to gain unauthorized information by obtaining these passwords. These security threats on the passwords have ranged in sophistication and complexity. Known types of password guessing attacks can, in some cases, be driven by an individual's educated guesses, but more often are driven by automated processes that scan all possible random values, and/or target a specific set of words as large as the entire English language dictionary.

To improve password security, measurements can be taken to improve “Password Entropy” (hereinafter PE). Like in thermodynamics, “entropy” of a password is a measure of its mathematical “randomness”. A great challenge in the area of increasing this entropy, however, lies in the struggle to create a balance between user workable passwords and one that is not vulnerable to internal and external attacks.

Consequently, improvements are desired that can enhance password security by increasing its entropy without imposing cumbersome restrictions on the user.

### SUMMARY OF THE INVENTION

The short comings of the prior art are overcome and additional advantages are provided through the provision of a method, a computer readable medium, and an apparatus for providing data security for a computing environment, especially one having a plurality of nodes. The apparatus comprises a password mechanism residing in a storage location in the computing environment; and a user specific dictionary including entries generated by the password mechanism about each user by retrieving available data from one or more databases. The password mechanism validates a proposed password for the user by comparing it with entries in the user specific dictionary and rejecting it when the proposed password matches at least part of any entry in the user specific dictionary.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is an illustration of a computing environment having a plurality of nodes;

FIG. 2 is an illustration of a password driven mechanism as per one embodiment of the present invention;

FIG. 3 is a depiction of a user specific dictionary such as used by the computing environment of FIG. 1 as per one embodiment of the present invention; and

FIG. 4 is a flowchart depiction of the steps taken by the password mechanism of the present invention.

### DESCRIPTION OF THE INVENTION

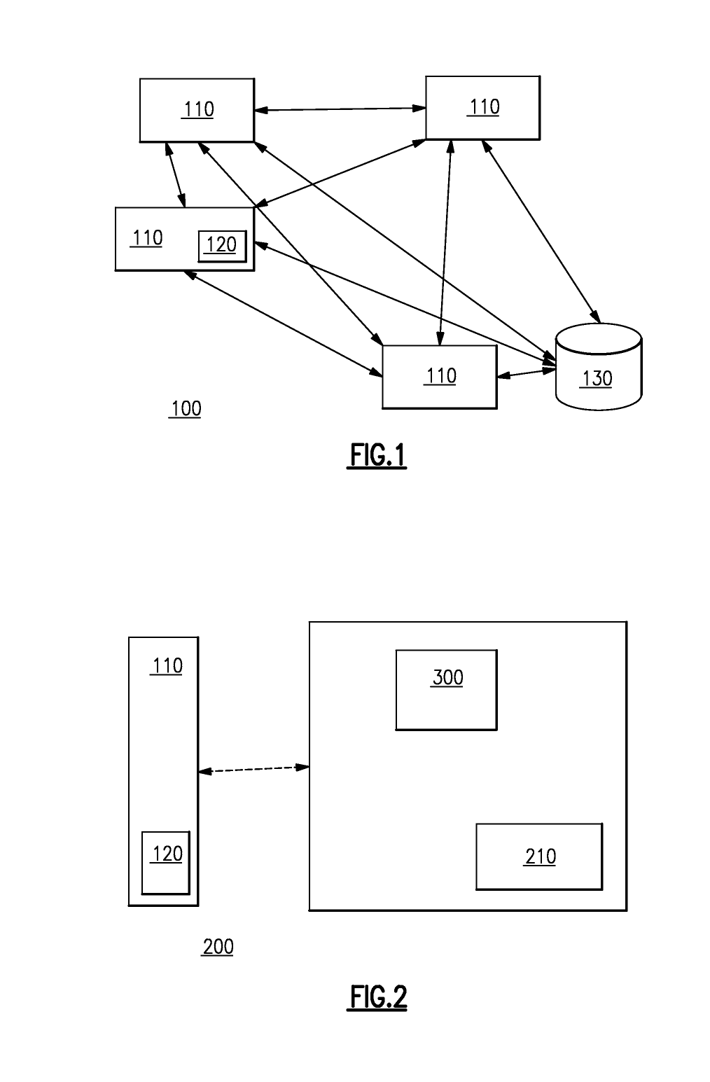

FIG. 1 is an illustration of a computing environment 100 having a plurality of nodes 110 in processing communication with one another. The nodes 110 can comprise a variety of devices ranging from single computers to large servers. The nodes also either include or have access to a memory location. In the example provided in FIG. 1, data can be stored in a variety of memory locations across the networked environment 100 such as on a memory component 120, depicted as a location embedded as part of a separate device 130. For example, the memory component 120 can be the hard drive of a single computer while a memory device 130 can comprise of a storage unit such as a server, disposed locally or remotely, or other similar devices as known to those skilled in the art.

The memory device 130 and the memory component 120 are in processing communication with each other and/or the nodes. In one embodiment, the nodes 110 are enabled to store or retrieve data from either the device 130 and/or component 120. The environment 100 therefore can use the device(s) and components to either provide redundant systems with one component or device providing backup to another, or alternatively as complementary units, to enable faster processing of data by splitting storage/data retrieval functions among the device(s)/component(s) as appropriate. In other embodiments, a hybrid of these two scenarios can be created where the memory component(s)/device(s) are designed to provide both functions or either function over time. In alternate embodiments, node access can be restricted selectively to one or more memory device or component.

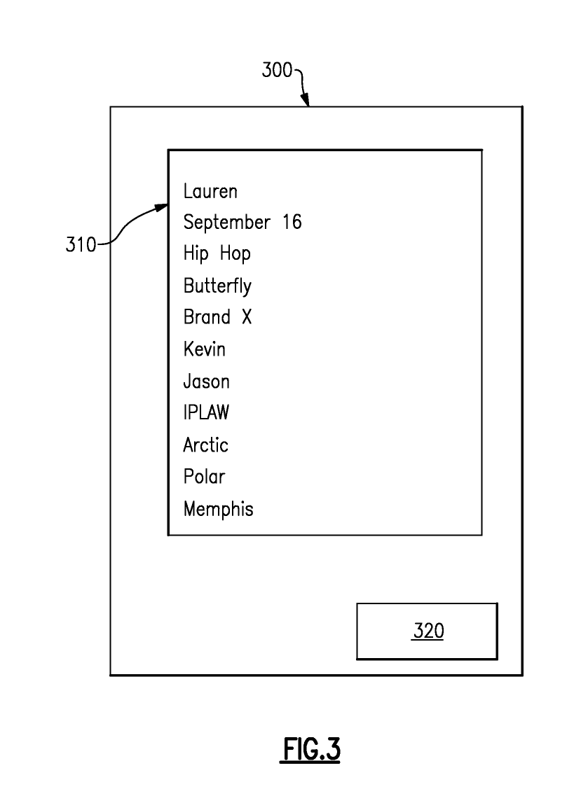

One or more operating systems having one or more applications can run on each node. The computing environment 100 is a secure environment, so processing entry is only enabled by use of a password driven mechanism. In one embodiment, the password driven mechanism can comprise a dictionary as shown in FIG. 2.

It should be noted, that, while the computing environment of FIG. 1, is discussed for ease of understanding to include a plurality of nodes so that the teachings of the present invention can be discussed in complex environments, the environment 100 can easily be represented by a single node such as a single computer. The password driven mechanism 200 as shown and will be discussed in conjunction with FIG. 2, in such an instance, will provide security to the single unit/node instead of more sophisticated computing environment 100 having a plurality of nodes.

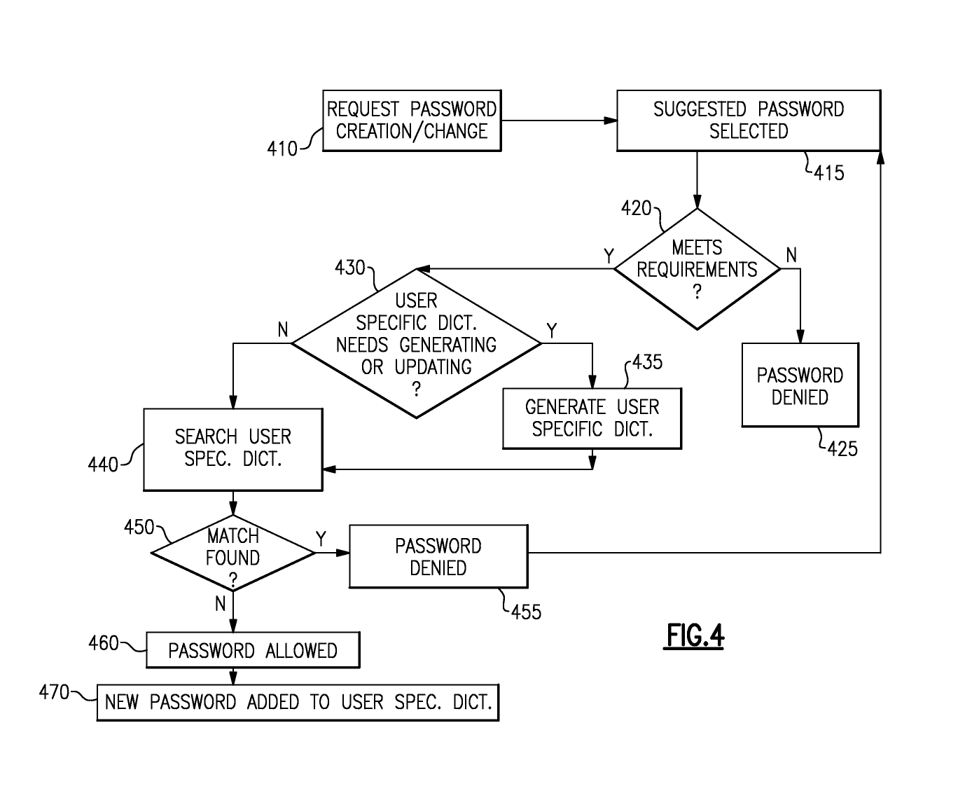

FIG. 2 is an illustration of a password driven mechanism 200 residing in or in processing communication with a node 110. The password driven mechanism 200 or simply password mechanism 200 (as will be hereinafter referenced), interacts with one or more user specific dictionaries 300. The user specific dictionaries are shown in FIG. 3 and will be discussed in more detail later.

The password mechanism 200 can reside on any node and/or storage unit or at a location central to the nodes and/or entire computing environment 100. For ease of understanding, an example of the workings of the password mechanism 200 of FIG. 2, as per one embodiment of the present invention, is provided by the flowchart depiction of FIG. 4.

As illustrated in FIG. 4, in block 410, when a password is proposed (to be created or changed/modified) for an existing or new user through one or more nodes (110) of the environment, the proposed password, as shown in block 415, is first checked to ensure that it meets any password requirements. The latter is shown in block 420. In some embodiments, there may be no such requirements imposed and accordingly this step will be skipped.

In the next step, shown in block 430, it is determined if a user specific dictionary is in existence for the particular user and is up to date. In case of a new user, where there is no user specific dictionary in existence, a new user specific dictionary can be generated in a following step shown in block 435. In one embodiment, for existing users, a last minute update may selectively be conducted in the step shown in block 435.

Once the user specific dictionary is retrieved (located, updated or generated), the proposed password is then compared to the entries in the dictionary as shown in block 440. If the word(s) or part of a word for the new/modified password that is being requested appears on the entry/list in the user specific dictionary (as correlates to the user/users), then the request for change or modification of the password is denied as shown in blocks 450 and 455. A new selection for a new proposed password needs to be made. In one embodiment, security components 210 and 320 of FIGS. 2 and 3 can be instrumental in performing the search, analysis and denial of the password by examining the user specific dictionary.

In different embodiments, the proposed password can be selected and reselected by the user or alternatively generated by an automated tool or program which is either part of one of the nodes 110 or is in processing communication with the computing environment 100.

In cases where the proposed password is not found in the user specific dictionary (in whole or in part), the proposed password will then be accepted as the new password as shown at 460. The new (proposed) password will be added to the user specific dictionary, as shown in block 470, so that it cannot be reused afterwards in creation of a subsequent password.

The password entry provides a single point of access to the environment 100. An incorrect password entry will result in access denial to the environment. If desired, additional security measures such as password lockouts that enable users only a selected number of tries to input the password correctly can be also be combined with the password mechanism (200) of the present invention.

In one embodiment of the invention, the password mechanism 200 calculates the time between password updates to search through the same type of publicly visible records and data that an unauthorized individual might use to improve a password guessing attack. Therefore user specific dictionaries will then also be updated as information changes over time. Consequently, each time the user updates/changes a password, the user specific dictionary 300 will already be loaded with most recent updated list of words that this user is restricted from using.

The password mechanism 200, in one embodiment uses data searching techniques such as those known to those skilled in the art. The mechanism can use a number of techniques to gather data available on a variety of databases including public sites. The mechanism can then customize select information used, to update/create each specific dictionary. The mechanism will use a classification or clustering of data to arrange gathered information such as in groups. For example, information may be deemed to be user specific or general in nature (and thus not to be included), or it may completely be undefined and grouped together based on other similar premise.

For data searching, a number of methods can be employed as known to those skilled in the art. In some embodiments, rule techniques can be employed to search for relationships between variables.

Any specific type of data searching can also be used in alternate embodiments. For example, the mechanism 200 can employ pattern searching for all users with specific dictionaries to determine commonalities that should be included in general for all user specific dictionaries. One such technique, involves searching for existing patterns in data as known to those skilled in the art. Pattern can be defined as a set of association rules, in one context. The same can be used for each specific user or subset of users.

Subject based data searching can also be used in other embodiments to establish data searching techniques involving search of public sites establishing associations between individuals by gathering large pools of publicly available data. This can even allow for research in more sensitive sites such as financial institution sites or others as selectively permitted by the user.

FIG. 3 is a depiction of a user specific dictionary 300 such as used by the computing environment 100 and the mechanism 200 as previously discussed in conjunction with embodiments of FIGS. 1 and 2. The user specific dictionary 300 is used in conjunction with the password driven mechanism 200. The user specific dictionary as discussed earlier is correlated to a specific user or alternatively to a group of users or an entity (a plurality of users that operate as one user) and includes one or more words that provide a security compromise if used by the user as a password or part of a password. In FIG. 3, a list of words are shown and referenced as 310.

One benefit of using the password driven mechanism 200 of the present invention is to increase password entropy. PE or “Guessing Entropy” is defined by the National Institute of Standards and Technology as a measure of the difficulty that an attacker has to guess the average password used in a system. In a document entropy is stated in bits. Therefore, when a password has n-bits of entropy, then an attacker has as much difficulty guessing the average password as in guessing an n-bit random quantity.

Serious threats to secure environments have been developed over the past few decades using various permutations of the “password guessing attack”. These types of attacks take many forms and present problems for enterprises and agencies that demand high security but must allow some leeway for users to remember their passwords. Known types of password guessing attacks can in some cases be driven by individuals making educated guesses, but more often are driven by automated processes that scan all possible random values, or target a specific set of words such as the entire English Language dictionary (called a “Dictionary Attack”). Network security protocols can be employed to reduce the number of online attacks. However, these methods would not work in the case of offline attacks where a malicious user may obtain an encrypted password and attempt to find a matching value through brute force guessing without the need to attempt a login.

Password lockout methods also can be employed, but when used alone these methods have many loopholes and will still allow an attacker to succeed in gaining access to the network. A password lockout method disables access by an identity after a certain (X) number of failed passwords has been attempted. Password lockouts have been used as the basis for obtaining unauthorized access creating new problems. In addition, brute force guessing cannot be entirely stopped, it can only be delayed by creating passwords that are difficult to obtain and/or guess. This can only be achieved by increasing PE.

Increasing PE, however, can affect ease of use. Passwords are often chosen by users based on familiar terms, events or other aspects of their life, making them easy to remember. Unfortunately, these passwords are easily guessed. Even when password composition rules disallow the users to incorporate part of an obvious user trait or information into the password, such as user name or birth date, it is still easy to decipher such passwords through information that is readily accessible such as through the internet. For example, a list of users' favorite musicians, authors, team names, and even more sensitive data such as names of family members and friends can become readily available to an attacker by looking at social network sites. These can make the password guessing attack more efficient.

Conventional methods of increasing PE employ longer passwords with many restriction policies, such as forcing the inclusion of at least one number in the password or inclusion of a series of uppercase letters and lowercase letters in a pattern. Other password composition rules may have minimum length requirements or even disallow words that are found in the dictionary (dictionary rules). Besides being cumbersome, these rules still offer limited protection to the user.

Referring back to FIG. 3, the dictionary 300 illustrates a user specific dictionary as per one embodiment of the present invention. The dictionary 300 will allow the user to pick his or her own password while it automatically uses techniques that allow an increase in entropy to be utilized without affecting usability. In one embodiment of the present invention, whenever the user changes his or her password (either by choice or due to expiration), the latest “dictionary”, such as the one shown in FIG. 3, is then associated with the particular user as referenced. Obvious permutations of words in this dictionary are checked against the requested password, and if a match is found, the password is rejected as “too obvious”. It should be noted that in one embodiment of the invention, the user-specific dictionary employs pre-processing to improve performance and increase its effectiveness. In this regard, however, the user-specific dictionary is limited to words and phrases that meet the minimum length criteria chosen by the administrators of the system. On the other hand, the dictionary includes common permutations of existing words and phrases. For example, substituting the digit zero for the letter “O”, or using the digit four to replace the word “for” in a phrase. Common permutations of upper/lower case, such as every-other-letter, should also be included in the search.

No matter what the case, however, the dictionary content is continually updated by a background process that is doing data searching more specifically associated with the user in question (as noted above). In addition, most recently used passwords can be included in the user specific dictionary so that part or all of the password previously used cannot be reused at least for a time period or selectively ever again for that particular user.

Furthermore, passwords typically have an expiration date, a set amount of time such that after which the password has to be changed. The password expiration dates are selective to users and/or enterprises and are designed specifically as a preventative measure to avoid discoverability due to password owners' prolonged use. For example one entity may decide to use a three month time period after which a password expires, while a different entity may use a six month expiration date. As discussed, the password mechanism 200 will be reviewing and updating the entries in the user specific dictionaries according to a preselected time frame, or by calculating time periods between password updates and searching through one or more data bases and public record websites etc to updating the user specific list.

Consequently, what may have passed as a valid or qualified password with satisfactory entropy may not necessarily pass on a subsequent attempted password selection, for example, based on more currently searched data that may have been collected between password expiration cycles. Such deployment is conveniently afforded through plug-ins or exit points within a security component (shown in FIG. 3 as 320).

In a preferred embodiment, user-specific dictionaries 300 can be used to improve existing dictionaries used by populated them with terms found by searching publicly visible data about specific users. Data gathering in such an instance may be similar as known to those skilled in the art to data gathered by sectors that deliver target advertising to specific customers. Using similar techniques, a dictionary can be created using information specific to each user within the system. The information provided in the dictionary then provides a basis for restricting users from using words found in them. These custom dictionaries, such as the one depicted in FIG. 3, will be populated by intelligent data searching entries, in one embodiment, as discussed earlier.

While the invention has been described in accordance with certain preferred embodiments thereof, those skilled in the art will understand the many modifications and enhancements which can be made thereto without departing from the true scope and spirit of the invention, which is limited only by the claims appended below.

What is claimed is:

1. An apparatus for providing data security for a computing environment, comprising:
a password mechanism residing in said computing environment; and
a user specific dictionary including entries generated by said password mechanism about a user by retrieving available data from one or more databases;
said password mechanism validating a proposed password for said user by comparing it with said entries in said user specific dictionary and rejecting it when said proposed password matches at least part of any entry in said user specific dictionary.

2. The apparatus of claim 1, wherein said password mechanism rejects a proposed password when said proposed password matches an entry in said user specific dictionary.

3. The apparatus of claim 1, wherein a plurality of user specific dictionaries are generated, each specific to a different particular user.

4. The apparatus of claim 1, wherein said password mechanism further includes a security component for accepting or rejecting a proposed password.

5. The apparatus of claim 1, wherein said databases used to generate entries in said user specific dictionary include publicly available databases.

6. The apparatus of claim 1, wherein said entries in said user specific dictionary are generated using data searching.

7. The apparatus of claim 1, wherein said proposed password is requested by a user.

8. The apparatus of claim 1, wherein said proposed password is generated by one or more programs residing in said computing environment.

9. The apparatus of claim 1, wherein said proposed password is generated by one or more programs residing outside but in processing communication with said computing environment.

10. The apparatus of claim 1, wherein said password mechanism automatically searches databases and updates said user specific dictionary.

11. The apparatus of claim 11, wherein updating of said user specific dictionary is performed based on preselected time intervals.

12. The apparatus of claim 10, wherein each user password is changed according to a preselected time frame.

13. The apparatus of claim 12 wherein said password mechanism calculates time between password updates and performs data searching through one or more data bases for updating said user specific dictionary.

14. The apparatus of claim 1, wherein said user specific dictionary also includes at least part of passwords used by said user in a past specific time period.

15. The apparatus of claim 13, wherein said user specific dictionary is dynamically modified by said password mechanism such that a password that may have passed as a valid or qualified password at one time may not necessarily pass on a subsequent attempted password selection due to said dictionary being updated based on data collected between password expiration cycles.

16. The apparatus of claim 15, wherein a dynamic change function of said password mechanism is provided by a plug-in within a security component of said password mechanism.

17. The apparatus of claim 15, wherein a dynamic change function of said password mechanism is provided by an exit point within a security component provided in said password mechanism.

18. The apparatus of claim 1, wherein said user includes a plurality of users grouped together as a single entity.

19. A method for providing a data security for a computing environment, comprising the steps of:
retrieving a user specific dictionary when a proposed password is received for a user;
when no user specific dictionary can be retrieved for said user, generating a user specific dictionary by accumulating available data from one or more databases relating to said user; and
comparing said proposed password to said user specific dictionary;
accepting said proposed password only when said proposed password does not match entries in said user specific dictionary.

20. A computer-readable medium having instructions recorded thereon, the instructions being executable by a processor to perform a method, the method comprising:
retrieving a user specific dictionary when a proposed password is received for a user;
when no user specific dictionary can be retrieved for said user, generating a user specific dictionary by a accumulating available data from one or more databases relating to said user; and
comparing said proposed password to said user specific dictionary;
accepting said proposed password only when said proposed password does not match entries in said user specific dictionary.
